(19) United States
(12) Patent Application Publication
(10) Pub. No.: US 2017/0074431 A1
(43) Pub. Date: Mar. 16, 2017

(54) Pipe Coupling Apparatus

(71) Applicant: Justin Gail Poyser, Gladstone, OR (US)

(72) Inventor: Justin Gail Poyser, Gladstone, OR (US)

(21) Appl. No.: 15/358,487

(22) Filed: Nov. 22, 2016

Related U.S. Application Data
(63) Continuation-in-part of application No. 14/523,667, filed on Oct. 24, 2014.

(51) Int. Cl. F16L 21/035; F16L 25/00; F16L 25/14

(52) U.S. Cl. CPC F16L 21/035; F16L 25/14; F16L 25/0072; F16L 2201/40

(57) ABSTRACT

A pipe coupling apparatus adapted to allow for the connection of older, common sewer or drain pipe made of concrete, clay or the like to that of the newer style polymers such as ABS, CPCV, PVC and the like. It accomplishes this through a novel connection method that eliminates having to cut off the bell end of the older sewer or drain pipe and provides for a method of stabilizing the alignment of the two connected pipes. The apparatus incorporates a pipe coupling and a flexible polymer transition sleeve, and depending on the dimensions of the pipes involved, may require an optional spacer seal ring. The assembly time is greatly reduced over the prior art methodologies and the coupled pipes are less likely to leak. It is available in both eccentric and concentric configurations.

### RELATED APPLICATIONS

This application incorporates by reference and is a continuation in part of U.S. Utility application Ser. No. 14/523,667 by the same sole inventor, entitled “Pipe Coupling Apparatus” filed Oct. 24, 2014.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to pipe couplings, and more particularly to underground sewer line repair technology.

### BACKGROUND

The present invention relates to a pipe coupling adapted to allow for the adaptation of underground common bell and spigot sewer or drain pipe generally of the same nominal diameter (although of different actual inner and outer diameters) made of concrete, clay or the like to that of the newer style polymers such as ABS, CPCV, PVC and the like. More particularly, to a multi component apparatus that can be used to repair older, broken sewer lines of varying dimensions, and in close quarters where an air and water tight seal is required by municipal regulation.

As the drainage piping under cities age, repairs or replacement of the existing clay, concrete, black iron piping is imminent. Unlike today's piping materials which are lightweight, inexpensive and made within tight dimensional tolerances, the older piping is heavy, expensive and more importantly, not subject to a standardized dimensional fabrications. While pipe sizing has been standardized for decades and is based on the internal diameter of the pipe, the internal and external dimensions of the bell ends of the pipe vary dramatically even within like material pipes. This is very problematic as the conventional repair of broken lines or replacement of line sections necessitates the removal of the bell and connection with the new pipe by butting together the old and new pipes and connecting them with a steel banded rubber sleeve, a bedding of mortar or fiber tape. This is undesirable as often there is not enough room to utilize a rubber sleeve, and it leaves the connection susceptible to misalignment. Additionally, often the removal of the bell end is not an option. Misalignment does not leave a smooth path for debris to flow down, and creates a spot where the potential for the development of blockages is high.

Henceforth, a pipe coupling apparatus that allows the air and water tight pipe connection of modern polymer piping to the bell or hub end of older style concrete, clay or similar sewer piping and that aligns these pipes in a sheer proof manner, would fulfill a long felt need in the plumbing industry. This new invention utilizes and combines known and new technologies in a unique and novel configuration to overcome the aforementioned problems and accomplish this.

### SUMMARY OF THE INVENTION

The general purpose of the present invention, which will be described subsequently in greater detail, is to provide a pipe coupling apparatus which is a transition fitting that is able to allow older style clay, concrete and iron sewage pipes to connect to the newer, (standardized dimension) polymer pipes in a manner that does not require the removal of the variable dimensioned bell end of the older style pipes and leaves a smooth bottomed flow path for the sewage traversing the piping system. In accordance with the invention, an object of the present invention is to provide an improved pipe coupling capable of a leak-proof connection with any of the conventional older style pipes in close quarters. This novel design goes against all of the conventional piping wisdom in that it has non-dimensionally mated piping (I.E. different materials, from different manufactures, from different eras, with different design specifications and tolerances) being inserted into each other rather than butted together and sealed.

It is another object of this invention to provide an improved pipe coupling apparatus capable of quickly connecting older style sewer pipe with the newer style polymer pipes in a manner that forms a leak tight seal.

The pipe coupling apparatus detailed herein, has many of the advantages mentioned heretofore and many novel features that result in a new pipe coupling apparatus which is not anticipated, rendered obvious, suggested, or even implied by any of the prior art, either alone or in any combination thereof.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is a perspective view of the bell end transition coupling;

FIG. 2 is a side view of the bell end transition coupling;

FIG. 3 is an end view of the bell end transition coupling;

FIG. 4 is a bell end view of the bell end transition coupling;

FIG. 5 is perspective view of the transition sleeve;

FIG. 6 is a side view of the transition sleeve;

FIGS. 7 and 8 are an end view of the transition sleeve;

FIG. 9 is a perspective view of the transition sleeve spacer seal ring;

FIG. 10 is a side view of the transition sleeve spacer seal ring;

FIGS. 11 and 12 are end views of the transition sleeve spacer seal ring;

FIG. 13 is a perspective view of the eccentric straight transition coupling;

FIG. 14 is a side view of the eccentric straight transition coupling;

FIGS. 15 and 16 are end views of the eccentric straight transition coupling;

FIG. 17 is a cross sectional view of the eccentric straight transition coupling inserted into the bell end of a clay pipe using a transition sleeve spacer seal ring in a transition sleeve to accomplish a leakproof seal;

FIG. 18 is a cross sectional view of the eccentric straight transition coupling inserted into the bell end of a clay pipe using a transition sleeve to accomplish a leakproof seal;

FIG. 19 is a cross sectional view of the eccentric bell end transition coupling inserted into the bell end of a clay pipe using a transition sleeve to accomplish a leakproof seal;

FIG. 20 is a cross sectional view of the concentric straight transition coupling inserted into the bell end of a clay pipe using a transition sleeve spacer seal ring in a transition gasket to accomplish a leakproof seal;

FIG. 21 is an outlet end view of a concentric straight transition coupling;

FIG. 22 is a cross sectional view of the concentric straight transition coupling inserted into the bell end of a clay pipe using a transition sleeve to accomplish a leakproof seal;

FIG. 23 is a cross sectional view of the concentric bell end transition coupling inserted into the bell end of a clay pipe using a spacer seal ring in a transition sleeveto accomplish a leakproof seal;

FIG. 24 is a cross sectional view of the concentric bell end transition coupling inserted into the bell end of a clay pipe using a transition sleeve to accomplish a leakproof seal; and

FIG. 25 is a cross sectional view of the eccentric bell end transition coupling inserted into the bell end of a clay pipe using a transition sleeve and a spacer seal ring to accomplish a leakproof seal.

### DETAILED DESCRIPTION

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed. There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

The pipe coupling apparatus of the present invention goes against all conventional concepts of connecting pipes that are designed for leakproof mating engagement (water tight and air tight). Such couplings are common with the repair of underground sewage/drainwater pipes where the existing system consists of old clay, cement or black iron piping must be mated to the newer polymer pipes. There were no industry standards for the inner and outer diameters of the old clay, cement or black iron piping, so the traditional method of connecting the non-standardized pipe to the newer style standardized polymer pipe was to butt the connecting ends together (regardless of the profile) and fabricate a leakproof seal over this interface. This seal may be with tape, cement/mortar, rubber sleeves or any combination thereof. The seal is also what held the two pipes aligned.

The pipe coupling apparatus herein does not butt the pipes together, rather is partially inserted into the older pipes and consists of either two or three components, a rigid pipe coupling (generally fabricated of a polymer adapted for connection with conventional polymer sewage pipe), a flexible sleeve (banded on either side of the sleeve's midpoint with compression straps), and an optional seal ring to go between the outer bell of the old pipe and the flexible sleeve. When installed, this system results in a pipe aligning, sheer proof, air tight and water tight repair. The eccentric configuration is designed for low flow and shallow angle applications whereas the concentric configuration is better suited for faster flowing sewage with steeper angles. The latter spacer seal ring is utilized depending upon the particulars of the dimensions of the bell end of the pipe being connected to. Since the outer dimensions of the bells differ, the spacer seal ring may or may not be needed. Because the rigid pipe coupling (with either the eccentric or concentric configuration) is partially inserted into the older pipes, the transition sleeve does not maintain the pipes in alignment, and a flexible transition sleeve may be made thinner, as it only need create a watertight seal and it is not used as a structural component of the assembly. It is to be noted that although the pipe coupling must be of a smaller cross sectional outer diameter than the cross sectional inner diameter of the older pipe, flow restriction is not an issue as the polymer pipe is much smoother on the inside and generates lower friction. As a result although the pipe diameter decreases, the resistance to flow is so much lower than that of the older style clay, black iron or cement pipe, there is an actual increase in the flow rate.

Since the pipes being connected carry solids or slurried material with them, there cannot be any cross sectional elevation differences between the pipes that create an area for the collection of debris. If any debris is allowed to collect, it will only exacerbate the problem and eventually clog the pipe. Hence, the conventional theory of connecting the pipes at the ends of their faces. The present pipe coupling apparatus allows for the partial insertion of the polymer pipe into the flow line area of the bell end of the older non-standardized pipe where the ends of the pipe coupling are of different diameters and are eccentric (or concentric as in the alternate embodiments), however the bottom of the pipe coupling has linear outer and inner surface, thereby eliminating the collection of debris when the direction of flow is from the polymer pipe coupling into the older, non-standardized pipe.

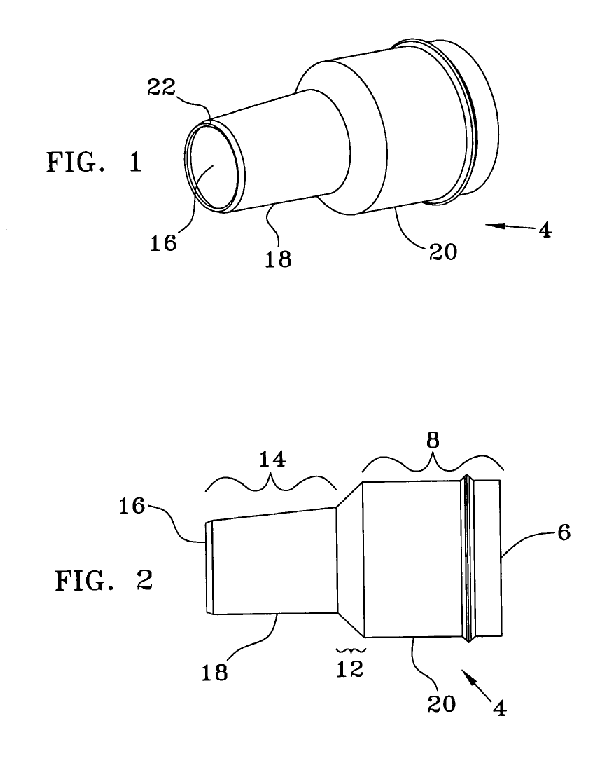

There are two styles of transitional couplings, a straight coupling 2 (also referred to as a plain end coupling) as seen in FIGS. 13-16, and a bell end coupling 4, as seen in FIGS. 1-4. Each style of coupling has a smaller diameter outlet end than the inlet end. Each of these types of couplings has embodiments with an eccentric configuration and embodiments with a concentric configuration.

In the eccentric configuration, the midpoint of the coupling's outlet end and the midpoint of the coupling's inlet end are not collinear, and do not lie on the longitudinal axis of the coupling. This is because the bottom edge of the coupling beginning at the outlet end, is either collinear or parallel with the bottom edge beginning at the inlet end of the coupling (depending on whether it is a straight coupling or a bell end coupling).

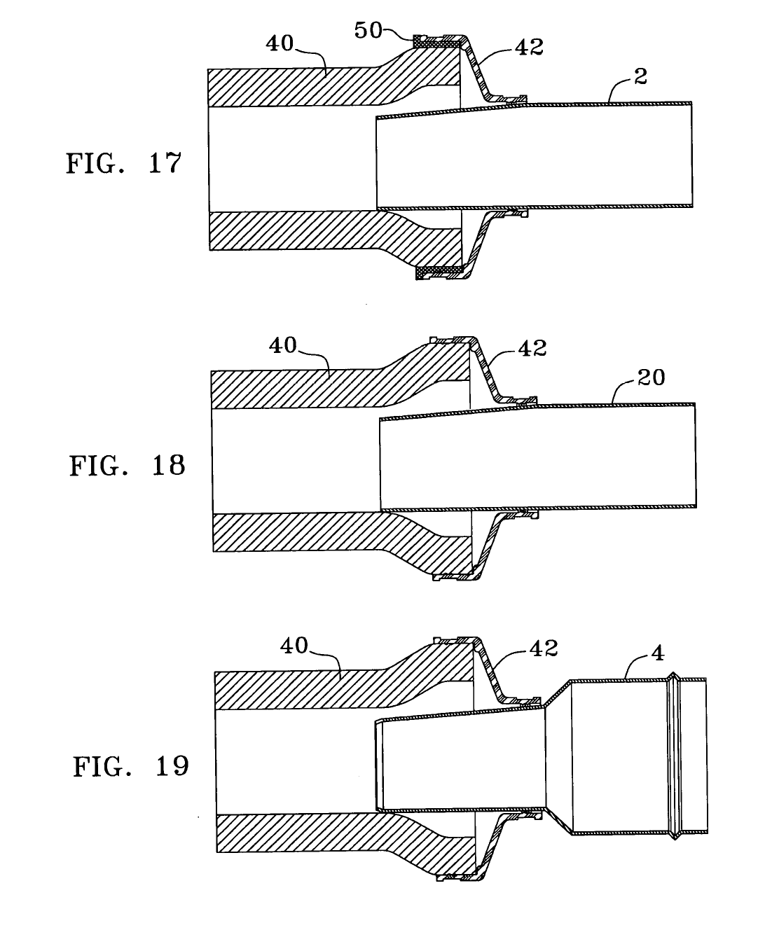

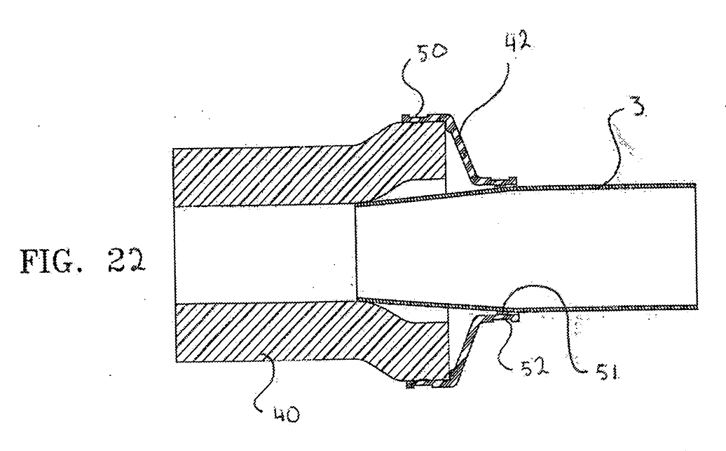

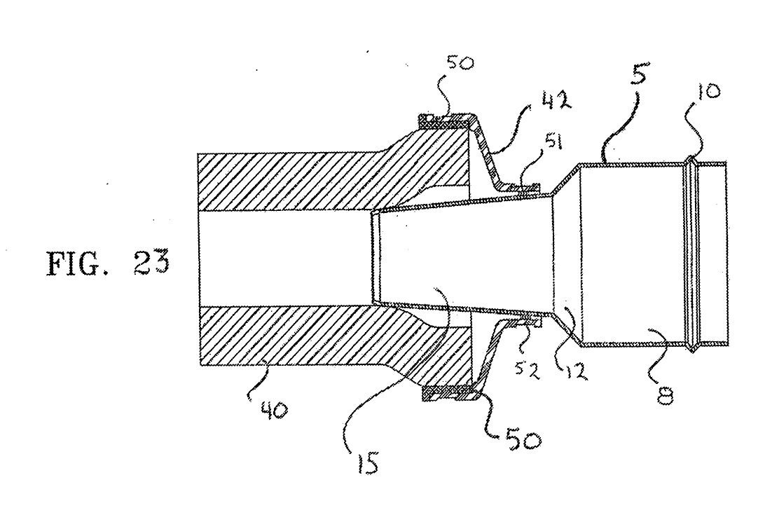

In the concentric configuration, the midpoint of the coupling's outlet end and the midpoint of the coupling's inlet end are collinear, both lying on the longitudinal axis of the coupling. The eccentric configuration of the straight transition coupling 2 is best seen in FIG. 17 whereas the alternate embodiment concentric configuration straight coupling 3 is best seen in FIG. 22. The eccentric configuration of the bell end coupling 4 is best seen in FIG. 19 whereas the alternate embodiment concentric configuration bell end coupling 5 is best seen in FIG. 23.

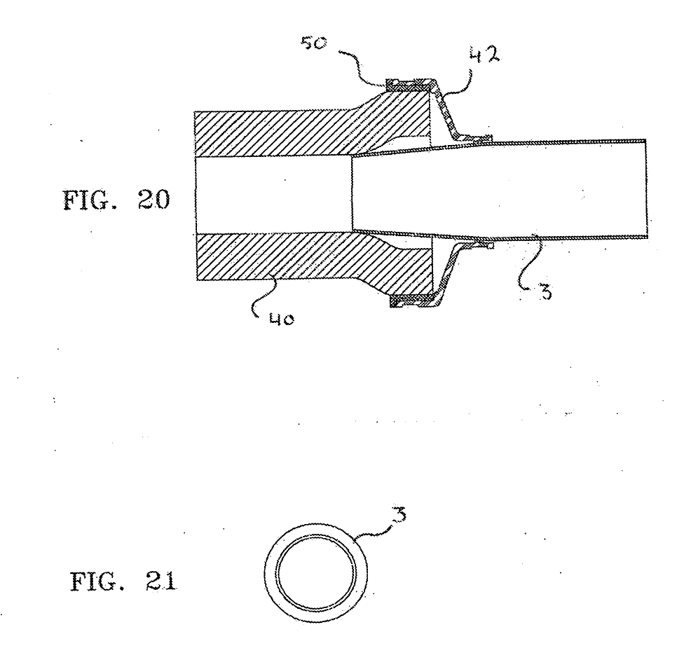

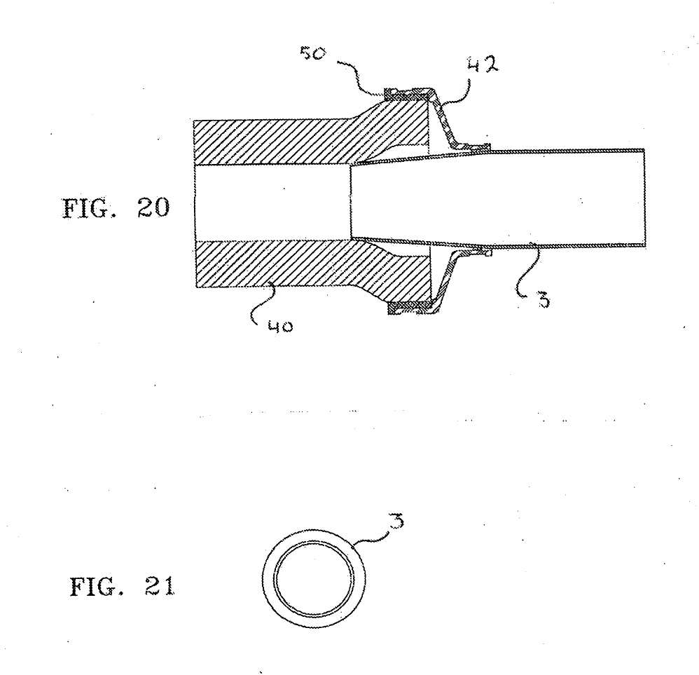

Regardless of the style and configuration of the couplings 2, 3, 4 and 5 they each connect identically by the insertion of their tapered outlet end into the bell end of an older pipe. Preferably the tapers of the coupling's outlet ends will accommodate complete circular frictional engagement with the inner wall of the bell end of the older pipe as shown in FIGS. 20,22 and 23 although since there were no dimensional standards when much of the infrastructure of the USA was being built, the outer diameters of the coupling's outlet ends will only accommodate partial circular frictional engagement with the inner wall of the bell end of the older pipe as shown in FIGS. 17-19. In such cases the plain end coupling 2 or alternate embodiment plain end coupling 3 will just be inserted to a deeper depth so as to give the assembly more structural rigidity. (The bell end coupling 4 and alternate embodiment bell end coupling 5 will be available with longer outlet sections 14 so as to also accommodate such deeper insertion.)

The reason for the two different styles of transitional couplings is because their leakproof mating is dependent on what type of fitting is on the new pipe that the coupling will mate the old pipe to. Each length of newer polymer sewer pipe has a bell end and a plain end that fits inside the bell end of another length of pipe. This bell end design maintains a common bottom line of connected pipes so that at no point along the section of connected pipe lengths will there be any obstructions along the bottom of the joined pipes that may obstruct the flow of sewage or stop heavier debris. The new pipe may have their bell end damaged wherein the bell would have to be cut off for connection to the transitional coupling, or the new pipe may have been installed backwards where the plain end only is exposed. Either scenario necessitates the use of a bell end coupling. Although discussed and disclosed as linear couplings, it is known that alternate embodiments may be fabricated in 90, 45, 22.5, 60, and 30 degree (or similar) fittings.

Looking at both of the styles of the pipe coupling, it can be seen that the pipe couplings are each linear couplings (connecting pipes in a straight line) made up of different sized and shaped sections at either end corresponding to its method of connection with the next sequential pipe. Typically, one end of the pipe coupling will be connected to either the plain end or the bell end of a dimensionally corresponding polymer pipe length while the other end will be inserted into a clay, concrete, black iron (or the like) pipe beyond the uncut bell end. These connections will vary in the degree of their mating engagement because of the lack of pipe size standardization at the time much of the sewage infrastructure in America was installed. Thus the depth of insertion will vary somewhat.

The inlet section at one end of the eccentric configuration pipe couplings 2 or 4 will have in cross section, a round inlet end with a diameter of X units and the outlet section at the other end of the pipe coupling will have in cross section, a smaller round outlet end with a diameter of less than X units, wherein the ends are eccentric, such that the midpoint of the inlet end and the midpoint of the outlet end are not collinear and both do not lie on the longitudinal (linear) axis of the coupling. The outlet section and the inlet section always have bottom edges that are parallel to each other (the bell end pipe coupling 4) or that share or form a common linear bottom edge (straight end pipe coupling 2.) The pipe couplings are only of a uniform diameter throughout the inlet sections, that is to say, from their inlet end to approximately one half their length (up to the approximate midpoint of the pipe couplings or where the inlet section ends.) The outlet sections of the pipe couplings taper in cross sectional diameter, narrowing towards its outlet end. In the case of the concentric configuration, this taper is identical or uniform about the circumference of the transitional coupling so as to form a frustum, however in the case of the eccentric configuration there is no taper along the bottom edge of the coupling.

In the case of the straight pipe couplings 2 and 4, (eccentric or concentric configurations) from the approximate linear midpoint of the pipe coupling to the outlet end of the outlet section, it narrows in cross sectional area. The inlet section and outlet section in the eccentric configuration pipe coupling 3 share a common linear bottom edge along their lengths.

It is to be noted that both the straight coupling and bell end couplings bear the same eccentric or concentric outlet section end design wherein their outlet end is designed for insertion into a bell end of the older style clay, concrete or iron pipes. The eccentric pipe couplings with their uneven radial tapered outlet sections, have but one orientation, wherein their outlet section linear bottoms are parallel and adjacent to the linear bottom of the pipe they are to be coupled with and inserted into. This allows for a smooth transition for the one way flow of sewage along the length of the assembled pipe system from the residence to the main sewer. The concentric couplings, having an even radial (frustuconical) taper on their outlet sections (forming a frutum), require no particular orientation for insertion into the older style clay, concrete or iron pipes.

Looking at a bell end coupling 4, as seen in FIGS. 1-4 it can be seen that the bell end coupling 4 or 5 has a round inlet end 6 at the edge of the round cylindrical inlet section 8 of the coupling 4. Adjacent the inlet end 6 is an internal “O” ring groove 10 for the retention of a polymer “O” ring (not illustrated) that provides a water tight seal when a straight pipe end of a matingly engageable identical section of pipe is connected therein. At the other end of the round cylindrical inlet section 8 at the approximate longitudinal center of the bell end coupling 4, is a transition section 12 that tapers down uniformly from all sides so as to form a short frustum into the outlet sections 14 or 15. However, these are the only structural commonalities shared by the eccentric and concentric configurations.

In the eccentric bell end coupling 4, the outlet section 14 has an uneven radial taper, narrowing in diameter along its length, however its bottom linear edge 18 remains parallel with the bottom linear edge 20 of the inlet section 8. All other linear edges taken about the rest of the outlet section 14 will not lie parallel with a similar linear edge taken about the inlet section 8. The outlet section 14 also has an optional, tapered outer edge 22 to ease the entry of the bell end coupling 4 into the bell end of the older style pipe.

In the concentric bell end coupling 5 the outlet section 15 tapers radially inward at the same angle so as to form a frustum.

On the concentric configuration bell end coupling 5, the interface between the transition section 12 and the round inlet section 8 has a circular cross section with a midpoint that is concentric with the circular cross section midpoint of the inlet section 8, the circular cross section midpoint of the outlet section 15, and the midpoint of the circular cross section at the interface between the transition section 12 and the round outlet section 15.

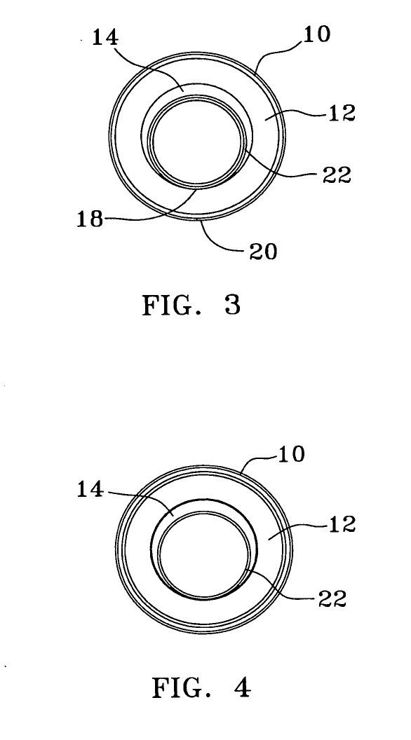

On the eccentric configuration bell end coupling 4, the interface between the transition section 12 and the round inlet section 8 has a circular cross section with a midpoint that is concentric with the circular cross section midpoint of the inlet section 8 6, and the midpoint of the circular cross section at the interface between the transition section 12 and the round outlet section 14. However the outlet section 14 has a circular cross section with a midpoint that is not collinear with the above three. This is best reflected in FIGS. 3 and 4.

Looking at an eccentric straight coupling 2 as seen in FIGS. 13-16, it can be seen that the straight coupling has a round inlet end 24 at the edge of the round cylindrical inlet section 26 of the coupling 2. The inlet section 26 extends to the approximate midpoint of the straight coupling 2 where it interfaces with the outlet section 28. The outlet section 28 tapers, narrowing in diameter along its length, however its bottom linear edge 30 remains uninterrupted and common with the bottom linear edge 32 of the inlet section 26. All other linear edges taken about the rest of the outlet section 28 will not lie parallel with a similar linear edge taken about the inlet section 26. The outlet section 28 has a round outlet end 34. This differs from the alternate embodiment concentric straight coupling 3 (FIGS. 20 and 21) which retains the round inlet end and tapers, narrowing in diameter along its length about the entire circumference such that the midpoints of the inlet and outlet ends of this concentric straight coupling lie along its longitudinal axis.

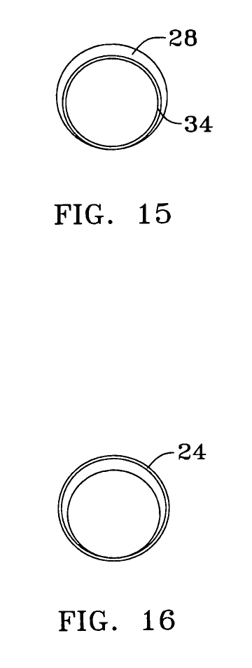

Similar to the eccentric bell end coupling 4, on the eccentric straight coupling 2 the inlet section 26 has a circular cross section that is eccentric with the circular cross section of the outlet section 28. This is best reflected in FIGS. 15 and 16.

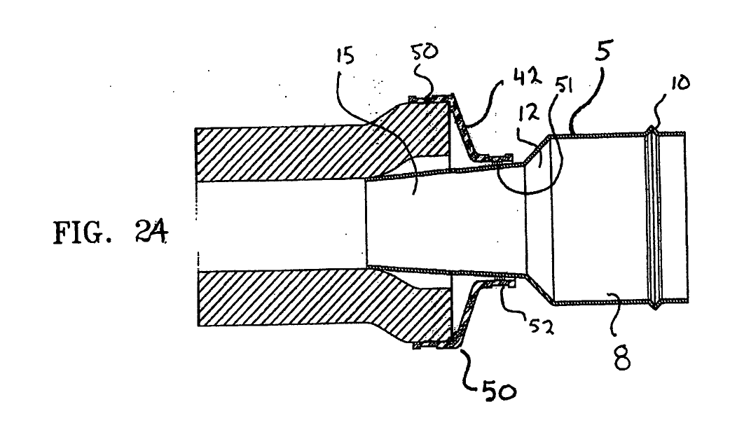

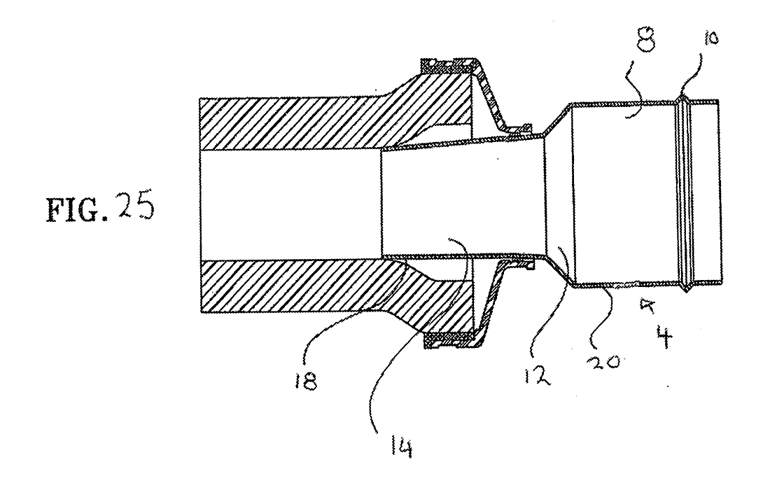

In operation, the outlet sections 14 or 15 of the bell end couplings or the outlet sections of the straight couplings 28 or 29 are inserted beyond the bell end of the old style, non-standardized pipe a short distance, until there is a snug friction fit between the outer surface of the tapered outlet sections and the inner surface of the older pipe 40 as illustrated in FIGS. 17-19, 20 and 23-25. As can be seen, in the case of the eccentric configured couplings 2 and 4, there is a straight flow path along the bottom of the couplings that lies parallel to the flow path of the bottom of the old pipe. This prevents the accumulation of any debris provided that the flow direction is from the couplings 2 and 4 and into the older pipe 40.

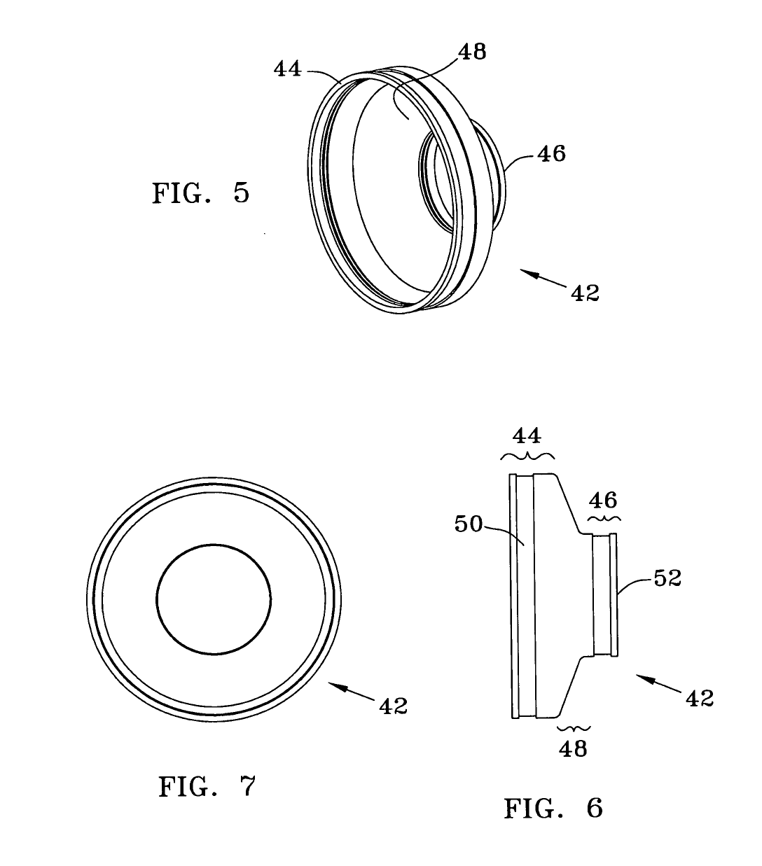

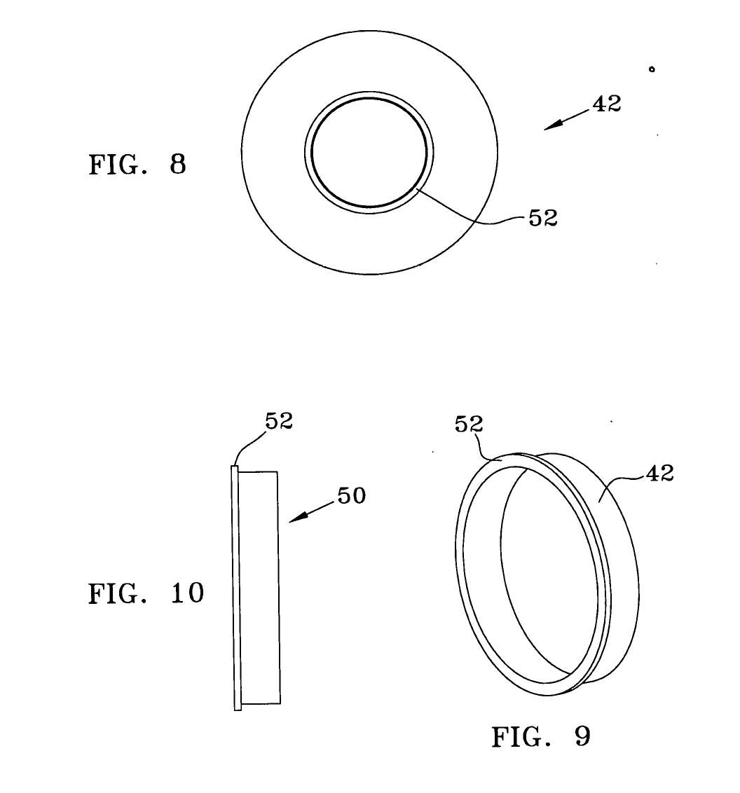

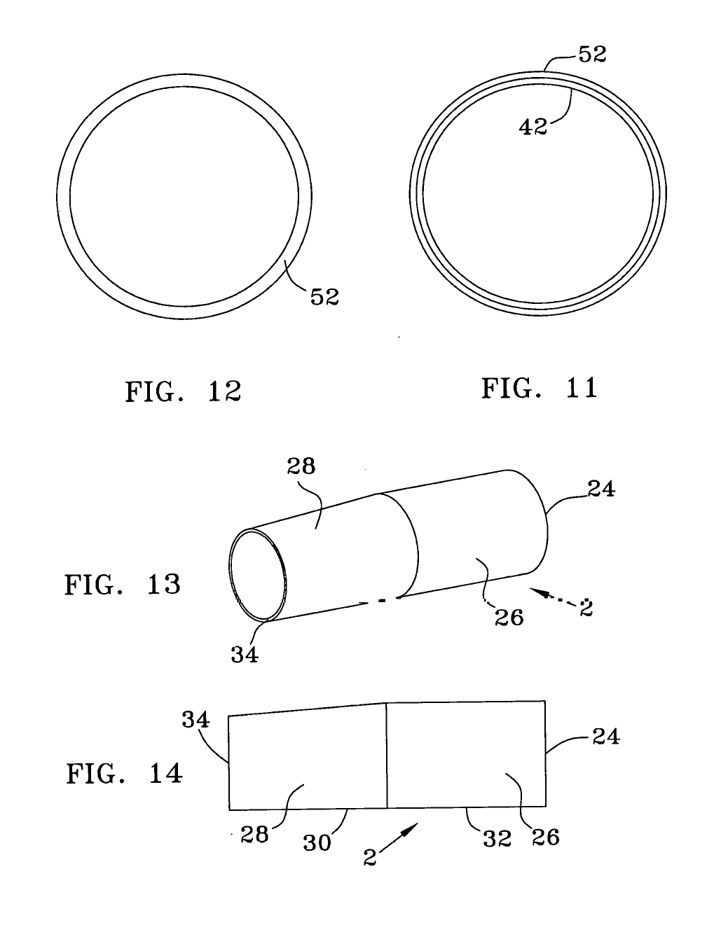

To ensure that there is no leakage from the engagement area there is a compressible polymer seal created. This uses one or both of a flexible polymer transition sleeve 42 (FIGS. 5-8) and an optional spacer seal ring 50 (FIGS. 9-12).

The transition sleeve 42 is a polymer sleeve that covers the zone of transition from the bell end of the old style pipe to the coupling's outlet section 14, 15, 28 or 29. The sleeve 42 has a bell end cover 44 connected to a smaller diameter coupling cover 46 by a transition region 48 that is tapered to accommodate the difference in their respective diameters. The bell end cover 44 and the coupling cover 46 have a large groove 50 and a small groove 52 formed thereon their exterior circular peripheries. This allows for the retention of a pair of exterior gear clamps or other tightenable, size adjustable, compression means to be banded on either side of the sleeve's midpoint.

Directly below the small groove 52 formed on the inside perimeter of the smaller diameter coupling cover 46, a seal ring 51 is formed. The compression means are capable of drawing in the interior surface of the bell end cover 44 into a leak tight contact with the bell end of the older style pipe and capable of drawing in the seal ring 51 on the interior surface of the coupling cover 46 into a leak tight contact with the outlet section 14, 15, 28 or 29 of the coupling 2, 3, 4 or 5. The inner diameter of the coupling cover 46 is dimensionally sized slightly larger than the outer diameter of the outlet section (approximately 0.020″) so that a minimum of elastic deformation is needed before compression to a full seal is accomplished. This close tolerance sizing may or may not exist with respect to the bell end cover 44 and the bell end of the old style pipe as the old style pipe varied considerably in their dimensions.

If the outer diameter of the bell end of the old style pipes is significantly smaller than the inner diameter of the bell end cover 44, compression of the bell end cover 44 with a compression means will not accomplish a leak tight seal. In this situation an optional spacer seal ring 50 (FIGS. 9-12) is placed onto the bell end of the old style pipe directly below the large groove 50 on the bell end cover 44, and is used to take up the extra space between the outside surface of the bell end of the old style pipe and the inner face of the bell end cover 44. The spacer seal ring 50 is made of a compressible, stretchable polymer having an outside diameter less than the inside diameter of the bell end cover 44. The wall thickness of the spacer seal ring 50 will be approximately ¼ inch in the preferred embodiment although the seal ring may be fabricated with any dimensions. The spacer seal ring 50 has an outer peripheral raised flange 52 that acts as a stop for the placement of the bell end cover 44 on top of the spacer seal ring and gives a visual indication of the alignment of the two parts before the compression means tightens down the aligned pair onto the bell end of the old style pipe.

Looking at FIGS. 17, 20, 23 and 25 the use of the spacer seal ring 50 between the bell end cover section of the flexible sleeve 42 and the bell end of the old style pipe is best illustrated.

Looking at FIGS. 18, 19, 22 and 24 the spacer seal ring 50 is eliminated, as the outer dimension of the bell end of the older style pipe is larger than that of its counterpart in FIGS. 17, 20, 23 and 25.

FIG. 19 merely illustrated the substitution of a bell end coupling 4 for the straight end coupling of FIG. 17.

As discussed herein, this novel pipe coupling apparatus allows a simple leak tight “insertion style” connection of modern polymer piping to older style non standardized pipes eliminating the need to cut the bell off of the older style pipes to accomplish the outdated industry standard “butt together” style connection. With the optional seal ring, virtually all the various different sizes of older sewer/drainage pipe can be connected in the method outlined herein.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Having thus described the invention, what is claimed as new and desired to be secured by Letters Patent is as follows:

1. A pipe coupling apparatus adapted for the connection of non-dimensionally standardized pipes to dimensionally standardized pipes comprising:
a bell end linear pipe coupling having an inlet section pipe length with a round inlet end defining an inlet cross sectional area, an outlet section pipe length with a round outlet end defining an outlet cross sectional area, and a tapered transition section pipe length connecting said inlet section pipe length to said outlet section pipe length,
wherein said outlet cross sectional area is smaller than said inlet cross sectional area;
wherein said bell end linear pipe coupling has a longitudinal axis; and
wherein said inlet end has an inlet end midpoint and said outlet end has an outlet end midpoint;
wherein said inlet end midpoint and said outlet end midpoints are not collinear on said longitudinal axis of the said bell end linear pipe coupling, and
wherein said outlet section pipe length has a non uniform radial taper about said outlet longitudinal axis.

2. The pipe coupling apparatus of claim 1 wherein said outlet section pipe length has a first bottom edge that lies parallel to a second bottom edge of said inlet section pipe length.

3. The pipe coupling apparatus of claim 2 wherein said outlet section pipe length is tapered and narrows to its smallest diameter at said outlet end.

4. The pipe coupling apparatus of claim 3 wherein said transition section pipe is configured as a frustum and is situated at the approximate midpoint of said linear pipe coupling.

5. The pipe coupling apparatus of claim 4 further comprising a flexible transition sleeve having a bell end cover at a distal end of said sleeve having a first diameter, and a coupling cover at a proximate end of said sleeve having a smaller, second diameter, said bell end cover connected to said coupling cover by a transition region that is tapered to accommodate the difference in their respective diameters, and
wherein said bell end cover is adapted to fit over a bell end of a pipe and said coupling cover is adapted to fit over a portion of the outlet section length.

6. The pipe coupling apparatus of claim 5 wherein said bell end cover has a first outer circumferential groove formed in an outer surface thereof to accommodate a first circular compression means, and said coupling cover has a second outer circumferential groove formed in an outer surface thereof to accommodate a second circular compression means.

7. The pipe coupling apparatus of claim 6 wherein said inlet section pipe length has an inner circumferential groove formed on an inner surface thereof adjacent said inlet end adapted for the retention of an internal “O” ring.

8. The pipe coupling apparatus of claim 7 further comprising an “O” ring, said “O” ring disposed within said inner circumferential groove formed on said inner surface of said inlet section pipe length.

9. A pipe coupling apparatus adapted for the connection of non-dimensionally standardized pipes to dimensionally standardized pipes comprising:
a bell end linear pipe coupling having an inlet section pipe length with a round inlet end defining an inlet cross sectional area, an outlet section pipe length with a round outlet end defining an outlet cross sectional area, and a tapered transition section pipe length connecting said inlet section pipe length to said outlet section pipe length,
wherein said outlet cross sectional area is smaller than said inlet cross sectional area;
wherein said bell end linear pipe coupling has a longitudinal axis; and
wherein said inlet end has an inlet end midpoint and said outlet end has an outlet end midpoint;
wherein said inlet end midpoint and said outlet end midpoints are collinear on said longitudinal axis of the said bell end linear pipe coupling, and
wherein said outlet section pipe length forms a frustum, having a uniform radial taper about said outlet longitudinal axis.

10. The pipe coupling apparatus of claim 9 wherein said outlet section pipe length is tapered and narrows to its smallest diameter at said outlet end.

11. The pipe coupling apparatus of claim 10 wherein said transition section pipe is configured as a frustum and is situated at the approximate midpoint of said linear pipe coupling.

12. The pipe coupling apparatus of claim 11 further comprising a flexible transition sleeve having a bell end cover at a distal end of said sleeve having a first diameter, and a coupling cover at a proximate end of said sleeve having a smaller, second diameter, said bell end cover connected to said coupling cover by a transition region that is tapered to accommodate the difference in their respective diameters, and
wherein said bell end cover is adapted to fit over a bell end of a pipe and said coupling cover is adapted to fit over a portion of the outlet section length.

13. The pipe coupling apparatus of claim 12 wherein said bell end cover has a first outer circumferential groove formed in an outer surface thereof to accommodate a first circular compression means, and said coupling cover has a second outer circumferential groove formed in an outer surface thereof to accommodate a second circular compression means.

14. The pipe coupling apparatus of claim 13 wherein said inlet section pipe length has an inner circumferential groove formed on an inner surface thereof adjacent said inlet end adapted for the retention of an internal “O” ring.

15. The pipe coupling apparatus of claim 14 further comprising an “O” ring, said “O” ring disposed within said inner circumferential groove formed on said inner surface of said inlet section pipe length.

16. The pipe coupling apparatus of claim 15 wherein said coupling cover has a circumferential rib formed on an inner surface thereof, said rib concentric to and beneath said second outer circumferential groove.
